(19) United States
(12) Patent Application Publication
(10) Pub. No.: US 2013/0310521 A1
(43) Pub. Date: Nov. 21, 2013

(54) RESIN COMPOSITE MATERIAL AND PROCESS FOR PRODUCING SAME

(71) Applicants: Daisuke Mukohata, Mishima-gun (JP); Nobuhiko Inui, Mishima-gun (JP); Katsunori Takahashi, Mishima-gun (JP); Keiichi Osano, Mishima-gun (JP)

(72) Inventors: Daisuke Mukohata, Mishima-gun (JP); Nobuhiko Inui, Mishima-gun (JP); Katsunori Takahashi, Mishima-gun (JP); Keiichi Osano, Mishima-gun (JP)

(21) Appl. No.: 13/982,553

(22) PCT Filed: Mar. 26, 2012
(86) PCT No.: PCT/JP2012/057746

§ 371 Date: Jul. 30, 2013

(30) Foreign Application Priority Data
Mar. 30, 2011 (JP) 2011-074048
Aug. 3, 2011 (JP) 2011-170363
Mar. 6, 2012 (JP) 2012-048853

(51) Int. Cl. C08F 8/42; C08G 64/42; C08F 110/02; C08G 63/91; C08F 112/08; C08F 120/10; C08F 8/32; C08F 110/06; C08G 69/48

(52) U.S. Cl. CPC C08F 8/42; C08F 110/06; C08G 64/42; C08F 110/02; C08G 69/48; C08F 112/08; C08F 120/10; C08F 8/32; C08G 63/91
USPC 525/244; 525/461; 525/418

(57) ABSTRACT

Disclosed herein are a resin composite material that has excellent mechanical strength and can be easily produced and a method for producing such a resin composite material.

The resin composite material is obtained by chemically bonding a reactive polyfunctional compound to both a thermoplastic resin and a carbon material having a graphene structure. The resin composite material production method includes: a first step of chemically bonding the reactive polyfunctional compound and the thermoplastic resin together; and a second step of chemically bonding the reactive polyfunctional compound and the carbon material having a graphene structure together.

### TECHNICAL FIELD

The present invention to a resin composite material reinforced with a carbon material and a method for producing such a resin composite material. More particularly, the present invention relates to a resin composite material reinforced with a carbon material having a graphene structure and a method for producing such a resin composite material.

### BACKGROUND ART

In recent years, carbon materials having a graphene sheet structure have attracted attention due to their high elastic modulus or high conductivity. By compounding such a carbon material having a graphene structure with a synthetic resin, it is possible to reinforce a product made of the synthetic resin or impart conductivity to the product. Particularly, graphene sheets, carbon nanotubes, exfoliated graphite, and the like are nanosized and have a large specific surface area. Therefore, it is considered that the carbon material has a high reinforcing effect when compounded with a synthetic resin.

In general, the carbon material is preferably uniformly dispersed in a matrix resin of a composite material to allow the composite material to sufficiently exhibit its effect. Therefore, Patent Document 1 discloses a method for achieving a uniformly dispersed state using a good solvent for a thermoplastic resin and a carbon material. According to this method, a resin composite material in a uniformly dispersed state can be obtained as long as there is a common solvent for a thermoplastic resin and a carbon material.

### PRIOR ART DOCUMENT

### Patent Document

Patent Document 1: JP-A-2005-264059

### SUMMARY OF THE INVENTION

### Problems to be Solved by the Invention

Such a carbon material as described above has a problem that it is very poor in dispersibility in solvent due to its strong cohesion force resulting from a π stacking force. Further, the production method disclosed in Patent Document 1 requires a large amount of solvent to disperse a carbon material in a resin. Therefore, this method has problems such as high cost of solvent and difficulty in solvent removal.

Further, the method disclosed in Patent Document 1 cannot provide a resin composite material having sufficiently high mechanical strength.

It is therefore an object of the present invention to provide a resin composite material that has excellent mechanical strength and can be easily produced and a method for producing such a resin composite material.

### Means for Solving the Problems

The present invention provides a resin composite material obtained by chemically bonding a reactive polyfunctional compound to both a thermoplastic resin and a carbon material having a graphene structure.

In a specific aspect of the resin composite material according to the present invention, the reactive polyfunctional compound has reactive functional groups and the reactive functional groups are selected from the group consisting of a carboxyl group, a carbonyl group, a sulfonic acid group, a hydroxyl group, an isocyanate group, a silyl group, a siloxy group, an alkoxy group, a vinyl group, chlorine, an aryl group, an amino group, an ether group, an ester group, an amide group, a thiol group, a (meth)acryl group, and an epoxy group. When the reactive polyfunctional compound has such reactive functional groups, the resin composite material can have higher mechanical strength.

In another specific aspect of the resin composite material according to the present invention, the reactive polyfunctional compound is a compound A having a structure represented by the following formula (1) or a compound B in which the compounds having a structure represented by the formula (1) are chemically bonded together.

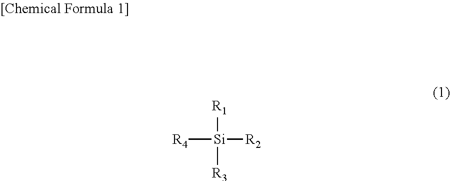

In the formula (1), R₁ to R₄ are functional groups independently selected from the group consisting of silyl, siloxy, alkoxy, vinyl, chlorine, aryl, alkyl, alkylamine ether, ester, amine, amide, hydrogen, thiol, methacryl, and epoxy, preferably from the group consisting of alkoxy, vinyl, alkyl, and (meth)acryl, and wherein at least one of R₁ to R₄ is any one of chlorine, siloxy, and alkoxy, and wherein when R₁ to R₄ contain a hydrocarbon group, the hydrocarbon group may have a branched or cyclic structure.

In this case, the compound A or the compound B is chemically bonded to both the thermoplastic resin and the carbon material having a graphene structure, which makes it possible to effectively enhance the mechanical strength of the resin composite material.

In the present invention, the reactive polyfunctional compound may be either the compound A or the compound B. In the case of the compound B, a moiety derived from at least one of the compounds having a structure represented by the formula (1) and at least one of moieties derived from the other compounds A having a structure represented by the formula (1) may be preferably chemically bonded to the thermoplastic resin and the carbon material having a graphene structure, respectively. In this case, in the compound B, a moiety derived from at least one of the compounds A constituting the compound B is chemically bonded to the thermoplastic resin and at least one of moieties derived from the other compounds A is chemically bonded to the carbon material having a graphene structure.

In another specific aspect of the resin composite material according to the present invention, the reactive polyfunctional compound is one reactive polyfunctional compound selected from a dioxime compound, a bismaleimide compound, and a quinone compound.

In another specific aspect of the resin composite material according to the present invention, the carbon material having a graphene structure is at least one carbon material selected from the group consisting of graphene, graphene oxide, carbon nanotubes, exfoliated graphite, and exfoliated graphite oxide. In this case, the carbon material having a graphene structure is nanosized and has a large specific surface area. Therefore, a small amount of such a carbon material can further enhance the mechanical strength of the resin composite material.

The carbon material having a graphene structure is more preferably exfoliated graphite oxide whose C/O ratio determined by elemental analysis is in a range of 2 to 20. In this case, the carbon material having a graphene structure has higher dispersibility and is therefore more uniformly dispersed in the thermoplastic resin, which makes it possible to further enhance the mechanical strength of the resin composite material.

In another specific aspect of the resin composite material according to the present invention, the thermoplastic resin is a polyolefin. In this case, the use of a general-purpose polyolefin makes it possible to reduce the cost of the resin composite material.

The present invention also provides a resin composite material production method for obtaining the above-described resin composite material according to the present invention. The production method according to the present invention includes: a first step of chemically bonding the reactive polyfunctional compound and the thermoplastic resin together; and a second step of chemically bonding the reactive polyfunctional compound and the carbon material having a graphene structure together.

In a specific aspect of the resin composite material production method according to the present invention, at least one of the first and second steps is performed during a process of kneading using an extruder. In this case, the first or second step can be performed during a process of kneading raw materials in an extruder.

In another specific aspect of the resin composite material production method according to the present invention, the first and second steps are performed during a process of supplying and kneading the thermoplastic resin, the reactive polyfunctional compound, and the carbon material having a graphene structure to and in an extruder. In this case, the reactive polyfunctional compound is chemically bonded to both the thermoplastic resin and the carbon material having a graphene structure during a process of kneading in an extruder. This makes it possible to simplify a production process.

In another specific aspect of the resin composite material production method according to the present invention, the second step is performed during the process of kneading in an extruder and the first step is performed after extrusion from the extruder. In this case, it is possible to optimize the step of chemically bonding the other of the thermoplastic resin and the carbon material having a graphene structure to the reactive polyfunctional compound.

### Effects of the Invention

The resin composite material according to the present invention is obtained by chemically bonding a reactive polyfunctional compound to both a thermoplastic resin and a carbon material having a graphene structure, which makes it possible to effectively enhance the mechanical strength of the resin composite material.

The resin composite material production method according to the present invention can provide a resin composite material according to the present invention having high mechanical strength.

### EMBODIMENTS OF THE INVENTION

Hereinbelow, the present invention will be described in detail.

(Resin Composite Material)

A resin composite material according to the present invention is obtained by chemically bonding a reactive polyfunctional compound to both a thermoplastic resin and a carbon material having a graphene structure. A conventional resin composite material obtained by simply kneading a thermoplastic resin and a carbon material does not exhibit sufficient mechanical strength, but according to the present invention, mechanical strength can be effectively enhanced because a reactive polyfunctional compound is chemically bonded to both a thermoplastic resin and a carbon material having a graphene structure.

(Reactive Polyfunctional Compound)

As a reactive polyfunctional compound to be used in the present invention, a various reactive polyfunctional compound can be used which have two or more reactive functional groups and can be chemically bonded to both a thermoplastic resin and a carbon material having a graphene structure. Examples of such reactive polyfunctional compounds include the following a) to c).

a) A reactive polyfunctional compound having reactive functional groups selected from the group consisting of a carboxyl group, a carbonyl group, a sulfonic acid group, a hydroxyl group, an isocyanate group, a silyl group, a siloxy group, an alkoxy group, a vinyl group, chlorine, an aryl group, an amino group, an ether group, an ester group, an amide group, a thiol group, a (meth)acryl group, and an epoxy group. Examples of such a reactive polyfunctional compound a include: a compound having carboxyl groups such as dicarboxylic acid (e.g., maleic acid, terephthalic acid); a compound having sulfonic acid groups such as disulfonic acid (e.g., 1,5-naphthalenedisulfonic acid); a compound having hydroxyl groups such as glycol (e.g., ethylene glycol); a compound having isocyanate groups such as diisocyanate (e.g., hexamethylene diisocyanate, phenylene diisocyanate); a compound having vinyl groups such as divinyl (e.g., divinyl benzene); a compound having amino groups such as diamine (e.g., phenylenediamine, ethylenediamine) and triamine (e.g., pyridine-2,3,6-triamine); a compound having thiol groups such as dithiol (e.g., 1,2-ethanedithiol); a compound having (meth)acryl groups such as di(meth)acrylate (e.g., 1,9-nonanediol diacrylate) and tri(meth)acrylate (e.g., trimethylolpropanetriacrylate); and a compound having epoxy groups such as diepoxy compound (e.g., ethylene glycol diglycidyl ether).

The reactive polyfunctional compound may have two or more different functional groups, and examples of such a reactive polyfunctional compound include methacryloyl chloride, 10-undecenoyl chloride, 3-amino-2-cyclohexene-1-one, aminophenol, aminobutanol allyl glycidyl ether, 4-hydroxybutylacrylate glycidyl ether, 3-(4-hydroxyphenyl)propionic acid, salicylic acid, and methyl 3-(4-hydroxyphenyl)propionate.

b) a compound A having a structure represented by the following formula (1) or a compound B in which the compounds having a structure represented by the formula (1) are chemically bonded together.

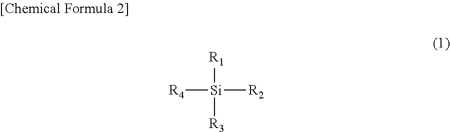

In the formula (1), R₁ to R₄ are functional groups independently selected from the group consisting of silyl, siloxy, alkoxy, vinyl, chlorine, aryl, alkyl, alkylamine, ether, ester, amine, amide, hydrogen, thiol, methacryl, and epoxy, preferably from the group consisting of alkoxy, vinyl, alkyl, and (meth)acryl, and wherein at least one of R₁ to R₄ is any one of chlorine, siloxy, and alkoxy, and wherein when R₁ to R₄ contain a hydrocarbon group, the hydrocarbon group may have a branched or cyclic structure.

Specific examples of the compound A having a structure represented by the formula (1) include 3-glycidoxypropyltriethoxysilane, vinyltriethoxysilane, and 3-aminopropyltriethoxysilane. Specific examples of the compound B in which the compounds A having a structure represented by the formula (1) are bonded together include alkoxy oligomers.

c) At least one reactive polyfunctional compound c selected from a dioxime compound, a bismaleimide compound, and a quinone compound.

In the case of the reactive polyfunctional compound c selected from the group consisting of a dioxime compound, a bismaleimide compound, and a quinone compound, their functional groups are radical-reactive functional groups and therefore react with radicals formed by dissociation of resin molecules in an extruder to form chemical bonding. Examples of the dioxime compound include p-quinonedioxime and p,p-dibenzoylquinonedioxime. Examples of the bismaleimide compound include N,N-p-phenylenebismaleimide, N,N-m-phenylenebismaleimide, and diphenylmethanebismaleimide. Examples of the quinone compound include hydroquinone, p-benzoquinone, and tetrachloro-p-benzoquinone.

The compound A having a structure represented by the formula (1) may be used or the compound B in which the compounds having a structure represented by the formula (1) are chemically bonded together may be used. When the compound A is used, both a thermoplastic resin and a carbon material having a graphene structure are chemically bonded to the compound A. This makes it possible to significantly enhance the mechanical strength of the resin composite material. Particularly, it is possible to significantly enhance the mechanical strength of the resin composite material at a high temperature of 80° C. or higher.

On the other hand, in the case of the compound B having a structure in which the compound having a structure represented by the formula (1) are bonded together, at least one of moieties derived from the compound having a structure represented by the formula (1) and at least one of the other moieties derived from the compound A having a structure represented by the formula (1) may be chemically bonded to a thermoplastic resin and a carbon material having a graphene structure, respectively. Also in this case, the thermoplastic resin and the carbon material having a graphene structure are bonded together via the compound B. Therefore, according to the present invention, it is possible to effectively enhance the mechanical strength of the resin composite material.

However, in the case of the compound B, both the thermoplastic resin and the carbon material having a graphene structure may be chemically bonded to a moiety derived from one of the compounds having a structure represented by the formula (1) and constituting the compound B. In this case, the compound B contains a moiety that is derived from the compound having a structure represented by the formula (1) and constituting the compound B and that is not chemically bonded to either of the thermoplastic resin and the carbon material having a graphene structure.

In the case of the compound B, the type of chemical bonding between the compounds having a structure represented by the formula (1) is not particularly limited, and examples of the chemical bonding include covalent bonding, ionic bonding, and van der Waals bonding. The chemical bonding is preferably covalent bonding between silicon atoms formed by a silane coupling reaction between the compounds having a structure represented by the formula (1).

(Thermoplastic Resin)

A thermoplastic resin to be used in the resin composite material according to the present invention is not particularly limited. Examples of such a thermoplastic resin include polyethylene, polypropylene, ethylene-vinyl acetate copolymer, acrylonitrile-styrene copolymer, acrylonitrile-butadiene-styrene copolymer, polyvinyl chloride, acrylic resin, methacrylic resin, polystyrene, polytetrafluoroethylene, polychlorotrifluoroethylene, polyvinylidene fluoride, ethylene-vinyl alcohol copolymer, vinylidene chloride resin, chlorinated polyethylene, polydicyclopentadiene, methylpentene resin, polybutylene, polyphenylene ether, polyamide, polyphenylene ether, polyphenylene sulfide, polyether ether ketone, polyaryl ether ketone, polyamide imide, polyimide, polyether imide, polysulfone, polyether sulfone, norbornene-based resin, polyvinyl alcohol, urethane resin, polyvinyl pyrrolidone, polyethoxyethyl methacrylate, polyformaldehyde, cellulose diacetate, polyvinyl butyral, polycarbonate, and polyester. These thermoplastic resins may be used singly or in combination of two or more of them. As the thermoplastic resin, a polyolefin is preferably used which is inexpensive and is easily heat-molded.

Alternatively, the thermoplastic resin to be used may be a modified thermoplastic resin modified with a functional group. By using such a modified thermoplastic resin, it is possible to easily chemically bond the thermoplastic resin to the reactive polyfunctional compound by a reaction between the reactive polyfunctional compound and a modified portion of the modified thermoplastic resin. As such a modified thermoplastic resin, various modified thermoplastic resins can be used which are modified with a functional group that can react with the reactive functional group of the reactive polyfunctional compound.

For example, when the reactive polyfunctional compound has an amino group, a modified thermoplastic resin having a modified portion that can react with an amino group, such as a maleic anhydride-modified polyolefin or a chlorinated polyolefin, can be preferably used. Examples of the maleic anhydride-modified polyolefin include maleic anhydride-modified polypropylene and maleic anhydride-modified polyethylene. Examples of the chlorinated polyolefin include chlorinated polypropylene and chlorinated polyethylene. When the reactive polyfunctional compound is the compound A having a structure represented by the formula (1) or the compound B and has an amino group, the modified thermoplastic resin to be used is more preferably a maleic anhydride-modified polyolefin that has high reactivity with an amino group. In this case, a modified portion of the maleic anhydride-modified polyolefin and an amino group of the compound A or the compound B are reacted by condensation to form chemical bonding.

(Carbon Material Having Graphene Structure)

In the present invention, a carbon material having a graphene structure is used to make a reinforcing effect on the resin composite material and, if necessary, to impart conductivity to the resin composite material. As such a carbon material having a graphene structure, at least one selected from the group consisting of graphene, graphene oxide, carbon nanotubes, exfoliated graphite, and exfoliated graphite oxide can be used.

It is to be noted that the “exfoliated graphite” refers to one that is obtained by exfoliating normal graphite and is made up of about several to 200 stacked graphene layers.

The carbon material having a graphene structure is more preferably a laminate of graphene oxide sheets, that is, exfoliated graphite oxide. The “exfoliated graphite oxide” refers to one obtained by oxidizing exfoliated graphite obtained by exfoliating original graphite or one obtained by exfoliating graphite oxide. Exfoliated graphite oxide is a graphene oxide laminate and is thinner than original graphite or graphite oxide. The number of stacked graphene oxide layers of exfoliated graphite oxide should be smaller than that of original graphite and is usually about several to 200.

When exfoliated graphite oxide is used as the carbon material having a graphene structure, the carbon material having a graphene structure can be bonded to the compound A or the compound B by a silane coupling reaction. In order to cause the silane coupling reaction, the ratio of oxygen atoms contained in the exfoliated graphite oxide, that is, the C/O ratio of the exfoliated graphite oxide determined by elemental analysis is preferably in the range of 2 to 20. It is to be noted that in the present invention, the “C/O ratio determined by elemental analysis” refers to the ratio of the number of moles of carbon atoms to the number of moles of oxygen atoms determined by elemental analysis.

The exfoliated graphite oxide has a shape with a relatively large aspect ratio. Therefore, when the exfoliated graphite oxide is uniformly dispersed in the resin composite material, its reinforcing effect against an external force exerted in a direction intersecting a lamination plane of the exfoliated graphite oxide can be effectively enhanced. It is to be noted that in the present invention, the “aspect ratio” refers to the ratio of the maximum size in the direction of the graphene lamination plane to the thickness of exfoliated graphite oxide.

If the aspect ratio of the exfoliated graphite oxide is too low, there is a case where its reinforcing effect against an external force exerted in a direction intersecting the lamination plane is not sufficient. On the other hand, if the aspect ratio of the exfoliated graphite oxide is too high, there is a case where its reinforcing effect is saturated and is therefore not enhanced in proportion to the aspect ratio. For this reason, the lower and upper limits of aspect ratio of the exfoliated graphite oxide are preferably 50 and 5000, respectively.

The ratio of the carbon material having a graphene structure to be blended is not particularly limited, but is preferably in the range of 0.5 to 40 parts by weight with respect to 100 parts by weight of the thermoplastic resin. If the ratio of the carbon material having a graphene structure to be blended is less than 0.5 parts by weight, there is a case where the reinforcing effect of the exfoliated graphite oxide derivative is insufficient. On the other hand, if the ratio of the carbon material having a graphite structure to be blended exceeds 40 parts by weight, there is a case where the resin composite material can have high stiffness but is brittle and is likely to be broken.

(Other Components)

Various additives may be used in the resin composite material according to the present invention without interfering with the object of the present invention. Examples of such additives include: a phenol-, phosphorus-, amine-, or sulfur-based antioxidant; a metal harm inhibitor; a halogenated flame retardant such as hexabromobiphenyl ether or decabromodiphenyl ether; a flame retardant such as ammonium polyphosphate or trimethyl phosphate; various fillers; an antistatic agent; a stabilizer; and a pigment.

When the reactive polyfunctional compound having radical reactivity is used, a radical generator such as a peroxide may be added. Such a radical generator can effectively cause the reaction of the reactive polyfunctional compound even when the temperature or share velocity of an extruder is relatively low.

(Resin Composite Material Production Process)

A production method according to the present invention is a method for obtaining a resin composite material according to the present invention. The method for producing a resin composite material according to the present invention includes: a first step of chemically bonding a reactive polyfunctional compound and a thermoplastic resin together; and a second step of chemically bonding a reactive polyfunctional compound and a carbon material having a graphene structure together.

In the present invention, the first step and the second step may be performed in different steps or in the same step. When the first step and the second step are performed in different steps, chemical bonding can be effectively formed in each of the steps. This makes it possible to further enhance mechanical strength.

When the first step and the second step are performed separately from each other, the order of the steps is not particularly limited. More specifically, the second step may be performed after the first step. Alternatively, the first step may be performed after the second step.

When the first step and the second step are performed at the same time, the process of production can be simplified. A method for forming chemical bonding in the first and second steps is not particularly limited per se. That is, the following various methods for forming chemical bonding can be used.

The type of chemical bonding between the reactive polyfunctional compound and the thermoplastic resin is not particularly limited, and examples of the chemical bonding include covalent bonding, ionic bonding, and van der Waals bonding. The chemical bonding may be preferably bonding formed by a radical reaction between the reactive polyfunctional compound and the thermoplastic resin.

The type of chemical bonding between the reactive polyfunctional compound and the carbon material having a graphene structure is not particularly limited, either, and examples of the chemical bonding include covalent bonding, ionic bonding, and van der Waals bonding. When the compound having a graphene structure is exfoliated graphite oxide, the chemical bonding is preferably bonding formed by a silane coupling reaction between the compound A and the exfoliated graphite oxide.

Hereinbelow, methods for forming chemical bonding using the reactive polyfunctional compounds a) to c), respectively will be described with reference to specific examples.

When the reactive polyfunctional compound a is used, chemical bonding should be formed by an appropriate method depending on the type of reactive functional group. Examples of such a method include heating, electron beam irradiation, and addition of a peroxide.

When the reactive polyfunctional compound a has an amino group, the above-described modified thermoplastic resin that can react with an amino group is preferably used as the thermoplastic resin. In this case, electron beam irradiation or addition of a peroxide is not required. Further, the thermoplastic resin is less likely to be degraded. Therefore, the mechanical strength of the resulting resin composite material can be effectively enhanced.

When the reactive polyfunctional compound is the compound A having a structure represented by the formula (1) or the compound B, a method can be used in which electron beam irradiation is performed during kneading of the reactive polyfunctional compound and the thermoplastic resin. Alternatively, a peroxide may be added. When the compound A has an amino group, as in the above case, the modified thermoplastic resin that can react with an amino group is preferably used. In this case, the thermoplastic resin is less likely to be degraded, and therefore, the mechanical strength of the resulting resin composite material can be effectively enhanced.

When the reactive polyfunctional compound is the reactive polyfunctional compound c, chemical bonding between the reactive polyfunctional compound c and the thermoplastic resin can be formed using a method such as heating, electron beam irradiation, or addition of a peroxide.

As described above, a method for forming chemical bonding between the reactive polyfunctional compound and the carbon material having a graphene structure is not limited, either, and an appropriate method can be used. For example, when the reactive polyfunctional compound has an amino group, exfoliated graphite oxide is preferably used as the carbon material having a graphene structure. The exfoliated graphite oxide has an epoxy group on its surface. Therefore, chemical bonding can be formed by reacting the amino group with the epoxy group. In this case, chemical bonding can be more easily formed and the mechanical strength of the resulting resin composite material can be more reliably enhanced.

When the reactive polyfunctional compound is the compound A having a structure represented by the formula (1) or the compound B and exfoliated graphite oxide is used as the carbon material having a graphene structure, chemical bonding can be formed by a silane coupling reaction.

As described above, exfoliated graphite oxide is preferably used as the carbon material having a graphene structure in the present invention, which makes it possible to easily form chemical bonding between the reactive polyfunctional compound and the carbon material having a graphene structure.

In the present invention, the thermoplastic resin and the carbon material having a graphene structure may be directly chemically bonded together. In this case, the mechanical strength of the resin composite material can be further enhanced. Such chemical bonding can be formed by, for example, a graft reaction between the thermoplastic resin and the carbon material having a graphene structure.

A preferred embodiment of the resin composite material production method according to the present invention will be described. In this preferred embodiment, a thermoplastic resin, a carbon material having a graphene structure, and a reactive polyfunctional compound are kneaded in an extruder. During the process of kneading, the reactive polyfunctional compound is chemically bonded to at least one of the thermoplastic resin and the carbon material having a graphene structure. The above-described chemical bonding can be formed during the process of kneading, and therefore a resin composite material can be easily produced.

More specifically, the following first and second methods can be mentioned.

In the first method, the reactive polyfunctional compound is chemically bonded to one of the thermoplastic resin and the carbon material having a graphene structure during the process of kneading. Then, a composite material is extruded from the extruder, and the reactive polyfunctional compound is chemically bonded to the other of the thermoplastic resin and the carbon material having a graphene structure outside the extruder. In this way, the reactive polyfunctional compound is chemically bonded to both the thermoplastic resin and the carbon material having a graphene structure to obtain a resin composite material according to the present invention.

In the second method, the reactive polyfunctional compound is chemically bonded to both the thermoplastic resin and the carbon material having a graphene structure during the process of kneading. In this case, a resin composite material according to the present invention can be immediately extruded from the extruder. Therefore, the process of production can be further simplified.

As described above, in the resin composite material production method according to the present invention in which a reactive polyfunctional compound is chemically bonded to both a thermoplastic resin and a carbon material having a graphene structure, the step of chemically bonding the reactive polyfunctional compound to one of the thermoplastic resin and the carbon material having a graphene structure is performed during the process of kneading in an extruder, and the step of chemically bonding the reactive polyfunctional compound to the other of the thermoplastic resin and the carbon material having a graphene structure may be performed at the same time as the above step during the process of kneading or after kneading and extrusion.

As the extruder, any appropriate extruder can be used as long as the thermoplastic resin, the carbon material having a graphene structure, and the reactive polyfunctional compound can be kneaded. An example of such an extruder includes an intermeshing twin screw extruder equipped with a kneading screw and two or more cylinder barrels in which the screw is provided, etc. An example of such a twin screw extruder includes an intermeshing co-rotating twin screw extruder equipped with a screw having a self-wiping twin screw element and a kneading disc element and two or more cylinder barrels.

A specific example of such an intermeshing co-rotating twin screw extruder includes Type “BT40” manufactured by Research Laboratory of Plastics Technology Co., Ltd.

By connecting, for example, a T-die to the tip of the extruder, a sheet-shaped resin composite material can be obtained.

The extruder needs to be configured so that it can be heated to set the temperature in the extruder to an appropriate temperature to knead the thermoplastic resin, the carbon material having a graphene structure, and the reactive polyfunctional compound. The heating temperature should be appropriately selected depending on the type of material to be used and the type of chemical bonding to be formed.

For example, when polypropylene is used as the thermoplastic resin, the temperature inside the extruder should be set to 180° C. or higher because the melting point of polypropylene is about 170° C. It is to be noted that the “melting point” refers to a melting peak temperature measured by DSC.

That is, the temperature in the extruder needs to be equal to or higher than the melting point of the thermoplastic resin to be used. The upper limit of the heating temperature should be set to a temperature at or below which the thermoplastic resin and the reactive polyfunctional compound are not deteriorated.

In the case of the above-described first method, that is, when chemical bonding is further formed outside the extruder, the resin composite material extruded from the extruder should be heated to an appropriate temperature or subjected to treatment, such as electron beam irradiation, outside the extruder to form chemical bonding.

In the first method, the step of chemically bonding the reactive polyfunctional compound and the thermoplastic resin together and the step of chemically bonding the reactive polyfunctional compound and the carbon material having a graphene structure together can be performed separately from each other. Therefore, chemical bonding can be formed by a method appropriately selected depending on the type of chemical bonding to be formed. This makes it possible to obtain a resin composite material having higher mechanical strength.

(Preferred Embodiment of Production Method Using Compound a with Structure Represented by Formula (1) or Compound B)

A preferred embodiment of the production method using, as the reactive polyfunctional compound, the compound A having a structure represented by the formula (1) or the compound B will be described. An embodiment of the production method using, as the reactive polyfunctional compound, the compound A having a structure represented by the formula (1) or the compound B in which the compounds A having a structure represented by the formula (1) are chemically bonded together will be described.

In this case, the compound A or the compound B and the thermoplastic resin are chemically bonded together in the first step. Further, the compound A or the compound B and the carbon material having a graphene structure are chemically bonded together in the second step. In this case, for example, in the first step, the compound A or the compound B and the thermoplastic resin are chemically bonded together to obtain a compound having a structure in which the compound A or the compound B is chemically bonded to the thermoplastic resin. Then, in the second step, the carbon material having a graphene structure is chemically bonded to the compound having the structure in which the compound A or the compound B is chemically bonded to the thermoplastic resin.

On the other hand, when the second step is first performed, a silane-modified carbon material, in which the compound A or the compound B is bonded to the carbon material having a graphene structure by silane coupling, is obtained in the second step. Then, after the second step, chemical bonding is formed between the silane-modified carbon material and the thermoplastic resin.

It is to be noted that the compound A used in the first step and the compound A used in the second step may be different from each other. In this case, a silane-coupled thermoplastic resin is obtained in the first step and a silane-modified carbon material is obtained in the second step. In this case, for example, when the first step is first performed, a silane-coupled thermoplastic resin is obtained, and then in the second step, the silane-coupled thermoplastic resin is silane-coupled to the carbon material having a graphene structure. On the other hand, when the second step is first performed, a silane-modified carbon material is obtained, and in the second step, the silane-modified carbon material is silane-coupled to the thermoplastic resin.

In this case, when the compound B is used, at least one of moieties having a structure represented by the formula (1) in the compound B can be chemically bonded to the thermoplastic resin, and at least one of the other moieties can be chemically bonded to the carbon material having a graphene structure.

During the polymerization of a monomer to obtain the thermoplastic resin, a compound containing a moiety derived from the compound A having a structure represented by the formula (1) may be added. This makes it possible to form chemical bonding between the compound containing a moiety derived from the compound A and the thermoplastic resin.

Alternatively, during the polymerization of a monomer to obtain the thermoplastic resin, the reactive polyfunctional compound may coexist with the monomer.

The resin composite material according to the present invention obtained by the above-described production method is molded by extrusion from the extruder, and therefore according to the present invention, resin composite material molded articles having various shapes can be obtained by extrusion molding. For example, by connecting a T-die to the extruder, a sheet-shaped resin composite material having high mechanical strength can be obtained.

Further, the resin composite material according to the present invention contains the carbon material having a graphene structure. This also makes it possible for the resin composite material to exhibit conductivity. Therefore, the resin composite material has potential for use as a material that exhibits conductivity.

Hereinbelow, the present invention will become apparent with reference to specific examples of the present invention. It is to be noted that the present invention is not limited to the following examples.

(Exfoliated Graphite Oxide)

Exfoliated graphite oxide used in Examples and Comparative Examples of the present invention was produced by the following method.

Exfoliated graphite oxide whose C/O ratio determined by elemental analysis was 2 was produced by the Hummer's method reported in J. Chem. Soc. W. S. Hummers et. al. 1958, 80, 1339.

Part of the exfoliated graphite oxide whose C/O ratio was 2 was heated in air at 200° C. for 2 hours to produce exfoliated graphite oxide whose C/O ratio determined by elemental analysis was 8.

### Example 1

Exfoliated graphite oxide (whose C/O ratio determined by elemental analysis was 8) produced by the above method was ultrasonically dispersed in a water/ethanol (50/50) mixed solution to prepare a mixture having a exfoliated graphite oxide concentration of 1 mg/mL. Then, acetic acid was added to the mixture to adjust the pH of the mixture to 5. Then, vinyltriethoxysilane was added thereto so that the percentage by weight of the vinyltriethoxysilane in the mixture was 0.5 wt %. Then, the mixture was ultrasonically treated for 1 hour. Then, ethanol was evaporated at room temperature and then the mixture was heated at 120° C. for 2 hours. Then, the resulting reaction mixture was ultrasonically treated in acetone, and the liquid was removed by filtration to obtain surface-modified exfoliated graphite oxide bonded with vinyltriethoxysilane.

Five parts by weight of the obtained surface-modified exfoliated graphite oxide and 100 parts by weight of polypropylene (manufactured by Prime Polymer Co., Ltd. under the trade name of “J-721GR”, tensile elastic modulus: 1.2 GPa, linear expansion coefficient: 11×10-5/K) were melt-kneaded in a Labo Plastomill (manufactured by Toyo Seiki Kogyo Co., Ltd. under the trade name of “R-100”) at 180° C. and press-molded into sheet form to obtain a resin composition sheet having a thickness of 0.5 mm.

Then, the resin composition sheet was irradiated with electron beams to chemically bond the vinyltriethoxysilane to the polypropylene to obtain a resin composite material sheet (thickness: 0.5 mm).

### Example 2

One hundred parts by weight of polypropylene (manufactured by Prime Polymer Co., Ltd. under the trade name of “J-721GR”, tensile elastic modulus: 1.2 GPa, linear expansion coefficient: 11×10⁻⁵/K), 5 parts by weight of exfoliated graphite oxide (whose C/O ratio determined by elemental analysis was 8) produced by the above method, and parts by weight of vinyltriethoxysilane were melt-kneaded in a Labo Plastomill (manufactured by Toyo Seiki Kogyo Co., Ltd. under the trade name of “R-100”) at 180° C. and press-molded into sheet form to obtain a resin composition sheet having a thickness of 0.5 mm.

Then, the resin composition sheet was irradiated with electron beams to chemically bond the polypropylene and the vinyltriethoxysilane together.

Then, the resin composition sheet was immersed in hot water at 80° C. for 24 hours to chemically bond the vinyltriethoxysilane and the exfoliated graphite oxide together to obtain a resin composite material sheet (thickness: 0.5 mm).

### Example 3

One hundred parts by weight of maleic anhydride-modified polypropylene (manufactured by Mitsui Chemicals Inc. under the trade name of “ADMER QE800”, tensile elastic modulus: 1.5 GPa, linear expansion coefficient: 10×10⁻⁵/K), 5 parts by weight of exfoliated graphite oxide (whose C/O ratio determined by elemental analysis was 8) produced by the above method, and 10 parts by weight of 3-aminopropyltriethoxysilane were melt-kneaded in a Labo Plastomill (manufactured by Toyo Seiki Kogyo Co., Ltd. under the trade name of “R-100”) at 180° C. and press-molded into sheet form to obtain a resin composition sheet having a thickness of 0.5 mm.

Then, the resin composition sheet was immersed in hot water at 80° C. for 24 hours to couple the 3-aminopropyltriethoxysilane. By doing so, a resin composite material sheet (thickness: 0.5 mm) was obtained in which the maleic anhydride-modified polypropylene and the exfoliated graphite oxide were bonded together via the 3-aminopropyltriethoxysilane.

### Example 4

A resin composite material sheet was obtained in the same manner as in Example 2 except that carbon nanotubes (manufactured by CNT under the trade name of “CTUBE-100”) were used instead of exfoliated graphite oxide.

### Example 5

An intermeshing co-rotating twin screw extruder (Type “BT40” manufactured by Research Laboratory of Plastics Technology Co., Ltd.) was prepared, which was equipped with a screw (diameter: 39 mm, L/D=35) constituted from a self-wiping twin screw element and a kneading disc element and a cylinder barrel divided into 10 parts. A T-die having a discharge port with a width of 150 mm and a thickness of 1 mm was connected to the tip of the extruder.

The 10 parts of the cylinder barrel were defined as first to tenth barrels from the upstream to downstream of the extruder. The temperatures of the first to fifth barrels, sixth to eighth barrels, and ninth to tenth barrels and the coat-hanger die were set to 180° C., 230° C., and 210° C., respectively.

Maleic anhydride-modified polypropylene (manufactured by Mitsui Chemicals Inc. under the trade name of “ADMER QE800”, tensile elastic modulus: 1.5 GPa, linear expansion coefficient: 10×10⁻⁵/K) was fed into a hopper and supplied to the extruder through a supply port at a supply rate of 10 kg/hr using a screw feeder. Exfoliated graphite oxide (whose C/O ratio determined by elemental analysis was 8) produced by the above method was fed through a side feeder provided in the third barrel at a rate of 500 g/hr. Further, 3-glycidoxypropyltriethoxysilane was supplied to the extruder through the fifth barrel at a supply rate of 500 g/hr using a micropump (“VC-102 MODEL 186-346” manufactured by Chuorika Co., Ltd.) and an injection nozzle. During this period, the extruder was operated at a screw rotation speed of 40 rpm and a resin composite material was discharged through the discharge port of the T-die to obtain a resin composite material sheet.

Then, the resin composite material sheet was immersed in hot water at 80° C. for 24 hours to chemically bond the 3-glycidoxypropyltriethoxysilane and the exfoliated graphite oxide together to obtain a resin composite material sheet.

### Example 6

The same T-die as used in Example 5 was connected to the tip of the same intermeshing co-rotating twin screw extruder as used in Example 5.

The temperature set of the cylinder barrel were defined as first to tenth barrels from the upstream to downstream of the extruder, the temperatures of the first to fifth barrels, sixth to eighth barrels, and ninth to tenth barrels and the coat-hanger die were set to 180° C., 220° C., and 200° C., respectively.

Polypropylene (manufactured by Prime Polymer Co., Ltd. under the trade name of “J-721GR”, tensile elastic modulus: 1.2 GPa, linear expansion coefficient: 11×10⁻⁵/K) was fed into a hopper and supplied to the extruder through a supply port at a supply rate of 10 kg/hr using a screw feeder. Exfoliated graphite oxide (whose C/O ratio determined by elemental analysis was 8) produced by the above method and p-quinonedioxime (“Vulnoc GM-P” manufactured by Ouchi Sinko Chemical Industrial Co., Ltd.) were fed through a side feeder provided in the third barrel at a rate of 500 g/hr and a rate of 150 g/hr, respectively, and the extruder was operated at a screw rotation speed of 40 rpm and a resin composite material was discharged through the discharge port of the T-die to obtain a resin composite material sheet.

### Example 7

A resin composite material sheet was obtained in the same manner as in Example 6 except that maleic anhydride-modified polypropylene (manufactured by Mitsui Chemicals Inc. under the trade name of “ADMER QE800”, tensile elastic modulus: 1.5 GPa, linear expansion coefficient: 10×10⁻⁵/K) was used instead of polypropylene in Example 6 and that phenylenediamine was used instead of p-quinonedioxime and its feed rate was changed to 200 g/hr.

### Example 8

As in the case of Example 5, a T-die was connected to the tip of the intermeshing co-rotating twin screw extruder used in Example 5.

The temperature set of the cylinder barrel were defined as first to tenth barrels from the upstream to downstream of the extruder, and the temperatures of the first to fifth barrels, sixth to eighth barrels, and ninth to tenth barrels and the coat-hanger die were set to 180° C., 220° C., and 200° C., respectively.

Polypropylene (manufactured by Prime Polymer Co., Ltd. under the trade name of “J-721GR”, tensile elastic modulus: 1.2 GPa, linear expansion coefficient: 11×10⁻⁵/K) was fed into a hopper and supplied to the extruder through a supply port at a supply rate of 10 kg/hr using a screw feeder. Exfoliated graphite oxide (whose C/O ratio determined by elemental analysis was 8) produced by the above method was fed through a side feeder provided in the third barrel at a rate of 500 g/hr. Then, a 4/1 mixture (weight ratio) of 1,9-nonanediol dimethacrylate (“LIGHT ESTER 1.9ND” manufactured by Kyoeisha Chemical Co., Ltd.) and dicumyl peroxide (manufactured by NOF Corporation) was supplied to the extruder through the fifth barrel at a supply rate of 100 g/hr using a micropump (“VC-102 MODEL 186-346” manufactured by Chuorika Co., Ltd.) and an injection nozzle. During this period, the extruder was operated at a screw rotation speed of 40 rpm and a resin composite material was discharged through the discharge port of the T-die to obtain a resin composite material sheet.

### Example 9

One hundred parts by weight of polyethylene (manufactured by Prime Polymer Co., Ltd. under the trade name of “1300)”, tensile elastic modulus: 1.3 GPa, linear expansion coefficient: 11×10⁻⁵/K), 5 parts by weight of exfoliated graphite oxide (whose C/O ratio determined by elemental analysis was 8) produced by the above method, and 10 parts by weight of vinyltriethoxysilane were melt-kneaded in a Labo Plastomill (manufactured by Toyo Seiki Kogyo Co., Ltd. under the trade name of “R-100”) at 180° C. and press-molded into sheet form to obtain a resin composition sheet having a thickness of 0.5 mm.

Then, the resin composition sheet was irradiated with electron beams to chemically bond the polypropylene and the vinyltriethoxysilane together.

Then, the resin composition sheet was immersed in hot water at 80° C. for 24 hours to chemically bond the vinyltriethoxysilane and the exfoliated graphite oxide together to obtain a resin composite material sheet (thickness: 0.5 mm).

### Example 10

One hundred parts by weight of polycarbonate (manufactured by Mitsubishi Engineering-Plastics Corporation under the trade name of “H-4000”, tensile elastic modulus: 2.4 GPa, linear expansion coefficient: 6.5×10⁻⁵/K), 5 parts by weight of exfoliated graphite oxide (whose C/O ratio determined by elemental analysis was 8) produced by the above method, and 10 parts by weight of 3-aminopropyltriethoxysilane were melt-kneaded in a Labo Plastomill (manufactured by Toyo Seiki Kogyo Co., Ltd. under the trade name of “R-100”) at 270° C. and press-molded into sheet form to obtain a resin composition sheet having a thickness of 0.5 mm.

Then, the resin composition sheet was immersed in hot water at 80° C. for 24 hours to couple the 3-aminopropyltriethoxysilane. By doing so, a resin composite material sheet (thickness: 0.5 mm) was obtained in which the polycarbonate and the exfoliated graphite oxide were bonded together via the 3-aminopropyltriethoxysilane.

### Example 11

One hundred parts by weight of polyester (manufactured by Mitsubishi Engineering-Plastics Corporation under the trade name of “5010R3-2”, tensile elastic modulus: 2.4 GPa, linear expansion coefficient: 10×10⁻⁵/K), 5 parts by weight of exfoliated graphite oxide (whose C/O ratio determined by elemental analysis was 8) produced by the above method, and 10 parts by weight of 3-aminopropyltriethoxysilane were melt-kneaded in a Labo Plastomill (manufactured by Toyo Seiki Kogyo Co., Ltd. under the trade name of “R-100”) at 240° C. and press-molded into sheet form to obtain a resin composition sheet having a thickness of 0.5 mm.

Then, the resin composition sheet was immersed in hot water at 80° C. for 24 hours to couple the 3-aminopropyltriethoxysilane. By doing so, a resin composite material sheet (thickness: 0.5 mm) was obtained in which the polyester and the exfoliated graphite oxide were bonded together via the 3-aminopropyltriethoxysilane.

### Example 12

One hundred parts by weight of polyamide (manufactured by Asahi Kasei Corporation under the trade name of “1300S”, flexual modulus: 2.7 GPa, linear expansion coefficient: 8×10⁻⁵/K), 5 parts by weight of exfoliated graphite oxide (whose C/O ratio determined by elemental analysis was 8) produced by the above method, and 10 parts by weight of 3-isocyanatepropyltriethoxysilane were melt-kneaded in a Labo Plastomill (manufactured by Toyo Seiki Kogyo Co., Ltd. under the trade name of “R-100”) at 270° C. and press-molded into sheet form to obtain a resin composition sheet having a thickness of 0.5 mm.

Then, the resin composition sheet was immersed in hot water at 80° C. for 24 hours to couple the 3-isocyanatepropyltriethoxysilane. By doing so, a resin composite material sheet (thickness: 0.5 mm) was obtained in which the polyamide and the exfoliated graphite oxide were bonded together via the 3-isocyanatepropyltriethoxysilane.

### Example 13

One hundred parts by weight of polystyrene (manufactured by DIC under the trade name of “CR-3500”, flexural modulus: 3.3 GPa), 5 parts by weight of exfoliated graphite oxide (whose C/O ratio determined by elemental analysis was 8) produced by the above method, and 10 parts by weight of vinyltriethoxysilane were melt-kneaded in a Labo Plastomill (manufactured by Toyo Seiki Kogyo Co., Ltd. under the trade name of “R-100”) at 220° C. and press-molded into sheet form to obtain a resin composition sheet having a thickness of 0.5 mm.

Then, the resin composition sheet was irradiated with electron beams to chemically bond the polystyrene and the vinyltriethoxysilane together.

Then, the resin composition sheet was immersed in hot water at 80° C. for 24 hours to chemically bond the vinyltriethoxysilane and the exfoliated graphite oxide together to obtain a resin composite material sheet (thickness: 0.5 mm).

### Example 14

One hundred parts by weight of polymethylmethacrylate (manufactured by Mitsubishi Rayon Co., Ltd. under the trade name of “VH000”, tensile elastic modulus: 3.3 GPa, linear expansion coefficient: 6×10⁻⁵/K), 5 parts by weight of exfoliated graphite oxide (whose C/O ratio determined by elemental analysis was 8) produced by the above method, and parts by weight of 3-aminopropyltriethoxysilane were melt-kneaded in a Labo Plastomill (manufactured by Toyo Seiki Kogyo Co., Ltd. under the trade name of “R-100”) at 240° C. and press-molded into sheet form to obtain a resin composition sheet having a thickness of 0.5 mm.

Then, the resin composition sheet was immersed in hot water at 80° C. for 24 hours to couple the 3-aminopropyltriethoxysilane. By doing so, a resin composite material sheet (thickness: 0.5 mm) was obtained in which the polymethylmethacrylate and the exfoliated graphite oxide were bonded together via the 3-aminopropyltriethoxysilane.

### Comparative Example 1

A resin composite material was obtained in the same manner as in Example 1 except that addition of vinyltriethoxysilane was omitted.

### Comparative Example 2

A resin composite material sheet was obtained in the same manner as in Example 1 except that electron beam irradiation was omitted.

### Comparative Example 3

A resin composite material sheet was obtained in the same manner as in Example 2 except that immersion in hot water at 80° C. for 24 hours was omitted.

### Comparative Example 4

A resin composite material sheet was obtained in the same manner as in Example 2 except that trimethylolpropane trimethacrylate was used instead of vinyltriethoxysilane.

### Comparative Example 5

A resin composite material sheet was obtained in the same manner as in Example 5 except that addition of 3-glycidoxypropyltriethoxysilane was omitted.

### Comparative Example 6

A resin composite material sheet was obtained in the same manner as in Example 6 except that addition of p-quinonedioxime was omitted.

### Comparative Example 7

A resin composite material sheet was obtained in the same manner as in Example 7 except that addition of phenylenediamine was omitted.

### Comparative Example 8

A resin composite material sheet was obtained in the same manner as in Example 8 except that addition of 1,9-nonanediol dimethacrylate was omitted.

### Comparative Example 9

The resin composite material sheet extruded from the extruder in Example 5 was used as Comparative Example 9.

### Comparative Example 10

A resin composite material was obtained in the same manner as in Example 9 except that addition of vinyltriethoxysilane was omitted.

### Comparative Example 11

A resin composite material was obtained in the same manner as in Example 10 except that addition of 3-aminopropyltriethoxysilane was omitted.

### Comparative Example 12

A resin composite material was obtained in the same manner as in Example 11 except that addition of 3-aminopropyltriethoxysilane was omitted.

### Comparative Example 13

A resin composite material was obtained in the same manner as in Example 12 except that addition of 3-isocyanatepropyltriethoxysilane was omitted.

### Comparative Example 14

A resin composite material was obtained in the same manner as in Example 13 except that addition of vinyltriethoxysilane was omitted.

### Comparative Example 15

A resin composite material was obtained in the same manner as in Example 14 except that addition of 3-aminopropyltriethoxysilane was omitted.

(Tensile Elastic Modulus)

Flat rectangular test pieces having a length of 70 mm and a width of 6.0 mm were cut from the resin composite material sheets obtained in Examples 1 to 14 and Comparative Examples 1 to 15. The tensile elastic modulus of each of the test pieces at 23° C. and 80° C. were measured in accordance with JIS K7161 and results are shown in Table 1.

TABLE 1

| | | | | | | Tensile Elastic | |
|---|---|---|---|---|---|---|---|
| | | | | | | Modulus GPa | |
| | Resin | Gr | Reactive Polyfunctional Compound | Remarks | Reference | 23° C. | 80° C. |
| Example 1 | PP | GO | Vinyltriethoxysilane | | | 4.95 | 1.82 |
| Example 2 | PP | GO | Vinyltriethoxysilane | | | 4.76 | 1.68 |
| Example 3 | Maleic acid-modified PP | GO | 3-aminopropyltriethoxysilane | | | 4.23 | 1.73 |
| Example 4 | PP | CNT | Vinyltriethoxysilane | | Example 2 | 3.92 | 1.13 |
| Example 5 | Maleic acid-modified PP | GO | 3-glycidoxypropyltriethoxysilane | Extrusion | | 4.88 | 1.91 |
| Example 6 | PP | GO | p-quinonedioxime | Extrusion | | 4.56 | 1.71 |
| Example 7 | Maleic acid-modified PP | GO | Phenylenediamine | Extrusion | Example 6 | 4.67 | 1.76 |
| Example 8 | PP | GO | 1,9-nonanediol dimethacrylate | Extrusion | | 3.74 | 1.69 |
| Example 9 | PE | GO | Vinyltriethoxysilane | | | 4.73 | 1.66 |
| Example 10 | Polycarbonate | GO | 3-aminopropyltriethoxysilane | | | 5.83 | 1.98 |
| Example 11 | Polyester | GO | 3-aminopropyltriethoxysilane | | | 5.78 | 1.79 |
| Example 12 | Polyamide | GO | 3-isocyanatepropyltriethoxysilane | | | 5.94 | 2.26 |
| Example 13 | Polystyrene | GO | Vinyltriethoxysilane | | | 6.51 | 1.89 |
| Example 14 | Polymethylmethacrylate | GO | 3-aminopropyltriethoxysilane | | | 6.82 | 2.18 |
| Comp. Ex. 1 | PP | GO | | | Example 1 | 2.01 | 0.68 |
| Comp. Ex. 2 | PP | GO | Vinyltriethoxysilane | Unbonded | Example 1 | 2.14 | 0.68 |
| Comp. Ex. 3 | PP | GO | Vinyltriethoxysilane | Unbonded | Example 2 | 2.23 | 0.76 |
| Comp. Ex. 4 | PP | GO | Trimethylolpropanetrimethacrylate | | Example 2 | 1.78 | 0.46 |
| Comp. Ex. 5 | Maleic acid-modified PP | GO | | Extrusion | Example 5 | 2.22 | 0.81 |
| Comp. Ex. 6 | PP | GO | | Extrusion | Example 6 | 2.41 | 0.83 |
| Comp. Ex. 7 | Maleic acid-modified PP | GO | | Extrusion | Example 7 | 2.22 | 0.81 |
| Comp. Ex. 8 | PP | GO | | Extrusion | Example 8 | 2.01 | 0.73 |
| Comp. Ex. 9 | Maleic acid-modified PP | GO | 3-glycidoxypropyltriethoxysilane | Unbonded | Example 5 | 2.20 | 0.85 |
| Comp. Ex. 10 | PE | GO | | | Example 9 | 1.93 | 0.61 |
| Comp. Ex. 11 | Polycarbonate | GO | | | Example 10 | 2.73 | 0.82 |
| Comp. Ex. 12 | Polyester | GO | | | Example 11 | 2.76 | 0.88 |
| Comp. Ex. 13 | Polyamide | GO | | | Example 12 | 3.01 | 0.93 |
| Comp. Ex. 14 | Polystyrene | GO | | | Example 13 | 3.50 | 1.08 |
| Comp. Ex. 15 | Polymethylmethacrylate | GO | | | Example 14 | 3.29 | 0.99 |

As shown in Table 1, it is found that the resin composite material sheets produced in Examples 1 to 4 according to the present invention have a much higher tensile elastic modulus than those produced in Comparative Examples 1 to 4. Particularly, it is found that their tensile elastic modulus at 80° C. is much higher. The reason for this is considered to be that in Examples 1 to 4, the polypropylene-based resin and the carbon material were bonded together via the silane compound. It is considered that this enhanced the mechanical strength of the resin composite material sheets of Examples 1 to 4.

Further, the resin composite material sheets of Examples 1 to 3 using exfoliated graphite as the carbon material have a higher tensile elastic modulus than that of Example 4 using carbon nanotubes as the carbon material. The reason for this is considered to be that the mechanical strength of the resin composite material sheets of Examples 1 to 3 was effectively enhanced by the exfoliated graphite oxide having a C/O ratio of 8.

In addition to that, the tensile elastic modulus of the resin composite material sheet of Example 2 is as high as that of the resin composite material sheet of Example 1. It can be seen from this that even when vinyltriethoxysilane, polypropylene, and exfoliated graphite oxide are first melt-kneaded, chemical bonding between vinyltriethoxysilane and polypropylene and chemical bonding between vinyltriethoxysilane and exfoliated graphite oxide can be selectively and effectively formed by appropriately adjusting reaction conditions.

It is found that the resin composite material sheets of Examples 5 to 8 have a much higher tensile elastic modulus at both 23° C. and 80° C. than those of Comparative Examples 5 to 8. The reason for this is considered to be that addition of the reactive polyfunctional compound was omitted in Comparative Examples 5 to 8, whereas in Examples 5 to 8,3-glycidoxypropyltriethoxysilane, p-quinonedioxime, phenylenediamine, and 1,9-nonanediol dimethacrylate were added as the reactive polyfunctional compound, respectively. That is, it is considered that in Examples 1 to 4, the reactive polyfunctional compound was chemically bonded to both maleic anhydride-modified polypropylene and polypropylene as the thermoplastic resin and exfoliated graphite oxide, which enhanced the tensile elastic modulus. More specifically, it is considered that in Example 5, maleic anhydride-modified polypropylene and 3-glycidoxypropyltriethoxysilane were chemically bonded together during the process of kneading in the extruder and 3-glycidoxypropyltriethoxysilane and exfoliated graphite oxide were chemically bonded together by immersing the resin composite material sheet in hot water at 80° C. for 24 hours, which enhanced the tensile elastic modulus.

Further, it is considered that in Examples 6 and 7, p-quinonedioxime or phenylenediamine was chemically bonded to polypropylene or maleic anhydride-modified polypropylene and exfoliated graphite oxide in the extruder, which significantly enhanced the tensile elastic modulus.

It is considered that in Example 8, 1,9-nonanediol dimethacrylate was chemically bonded to polypropylene and exfoliated graphite oxide during the process of kneading in the extruder, which significantly enhanced the tensile elastic modulus.

The resin composite material sheet of Comparative Example 9 has a lower tensile elastic modulus than that of Example 5. The reason for this is considered to be that the resin composite material sheet of Comparative Example 9 was obtained from the extruder after kneading in Example 1, and was therefore not subjected to treatment for chemically bonding 3-glycidoxypropyltriethoxysilane to exfoliated graphite oxide. However, the tensile elastic modulus of Comparative Example 9 is higher than that of Comparative Example 5. The reason for this is considered to be that maleic anhydride-modified polypropylene and 3-glycidoxypropyltriethoxysilane were chemically bonded together during the process of kneading.

Further, it is found that the resin composite material sheets produced in Examples 9 to 14 have a much higher tensile elastic modulus than those produced in Comparative Examples 10 to 15. Particularly, it is found that their tensile elastic modulus at 80° C. is much higher. The reason for this is considered to be that in Examples 9 to 14, each of the thermoplastic resins and the carbon material were bonded together via the silane compound.

1. A resin composite material obtained by chemically bonding a reactive polyfunctional compound to both a thermoplastic resin and a carbon material having a graphene structure.

2. The resin composite material according to claim 1, wherein the reactive polyfunctional compound has reactive functional groups, and wherein the reactive functional groups are functional groups selected from the group consisting of a carboxyl group, a carbonyl group, a sulfonic acid group, a hydroxyl group, an isocyanate group, a silyl group, a siloxy group, an alkoxy group, a vinyl group, chlorine, an aryl group, an amino group, an ether group, an ester group, an amide group, a thiol group, a (meth)acryl group, and an epoxy group.

3. The resin composite material according to claim 1, wherein the reactive polyfunctional compound is a compound having a structure represented by the following formula (1) or a compound in which the compounds having a structure represented by the formula (1) are chemically bonded together: 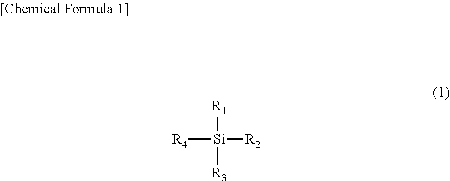
wherein R₁ to R₄ are functional groups independently selected from the group consisting of silyl, siloxy, alkoxy, vinyl, chlorine, aryl, alkyl, alkylamine, ether, ester, amine, amide, hydrogen, thiol, methacryl, and epoxy, preferably from the group consisting of alkoxy, vinyl, alkyl, and (meth)acryl, and wherein at least one of R₁ to R₄ is any one of chlorine, siloxy, and alkoxy, and wherein when R₁ to R₄ contain a hydrocarbon group, the hydrocarbon group may have a branched or cyclic structure.

4. The resin composite material according to claim 3, wherein the compound having a structure represented by the formula (1) or the compound in which the compounds having a structure represented by the formula (1) are chemically bonded together is the compound having a structure represented by the formula (1).

5. The resin composite material according to claim 3, wherein the compound having a structure represented by the formula (1) or the compound in which the compounds having a structure represented by the formula (1) are chemically bonded together is a compound B in which the compounds having a structure represented by the formula (1) are bonded together, and wherein in the compound B, a moiety derived from at least one of the compounds having a structure represented by the formula (1) is chemically bonded to the thermoplastic resin and at least one of moieties derived from the other compounds having a structure represented by the formula (1) is chemically bonded to the carbon material having a graphene structure.

6. The resin composite material according to claim 1, wherein the reactive polyfunctional compound is one reactive polyfunctional compound selected from the group consisting of a dioxime compound, a bismaleimide compound, and a quinone compound.

7. The resin composite material according to claim 1, wherein the carbon material having a graphene structure is at least one of the carbon materials selected from the group consisting of graphene, graphene oxide, carbon nanotubes, exfoliated graphite, and exfoliated graphite oxide.

8. The resin composite material according to claim 7, wherein the carbon material having a graphene structure is exfoliated graphite oxide, and wherein the exfoliated graphite oxide has a C/O ratio, as determined by elemental analysis, in a range of 2 to 20.

9. The resin composite material according to claim 1, wherein the thermoplastic resin is a polyolefin.

10. A method for producing the resin composite material according to claim 1, comprising:
a first step of chemically bonding the reactive polyfunctional compound and the thermoplastic resin together; and
a second step of chemically bonding the reactive polyfunctional compound and the carbon material having a graphene structure together.

11. The resin composite material production method according to claim 10, wherein at least one of the first and second steps is performed during a process of kneading using an extruder.

12. The resin composite material production method according to claim 11, wherein the first and second steps are performed during a process of supplying and kneading the thermoplastic resin, the reactive polyfunctional compound, and the carbon material having a graphene structure to and in an extruder.

13. The resin composite material production method according to claim 11, wherein the second step is performed during the process of kneading in an extruder and the first step is performed after extrusion from the extruder.

14. A method for producing the resin composite material according to claim 1, comprising the steps of:
supplying and kneading the thermoplastic resin, the reactive polyfunctional compound, and the carbon material having a graphene structure to and in an extruder to chemically bond the reactive polyfunctional compound to one of the thermoplastic resin and the carbon material having a graphene structure; and
chemically bonding the reactive polyfunctional compound to the other of the thermoplastic resin and the carbon material having a graphene structure.

15. The resin composite material production method according to claim 14, wherein the step of chemically bonding the reactive polyfunctional compound to the other of the thermoplastic resin and the carbon material having a graphene structure is performed during the process of kneading in an extruder to chemically bond the reactive polyfunctional compound to both the thermoplastic resin and the carbon material having a graphene structure during the process of kneading in an extruder.

16. The resin composite material production method according to claim 14, wherein the step of chemically bonding the reactive polyfunctional compound to the other of the thermoplastic resin and the carbon material having a graphene structure is performed after the reactive polyfunctional compound is chemically bonded to one of the thermoplastic resin and the carbon material having a graphene structure in the extruder and extruded from the extruder.
